(19) United States
(12) Patent Application Publication
(10) Pub. No.: US 2014/0355917 A1
(43) Pub. Date: Dec. 4, 2014

(54) CONNECTION STRUCTURE FOR A SHAFT AND A BEARING

(71) Applicants: Kuo-Chen Chang, New Taipei City (TW); Kuo-Chieh Chao, New Taipei City (TW)

(72) Inventors: Kuo-Chen Chang, New Taipei City (TW); Kuo-Chieh Chao, New Taipei City (TW)

(21) Appl. No.: 13/906,301

(22) Filed: May 30, 2013

(51) Int. Cl. F16C 17/02

(52) U.S. Cl. CPC F16C 17/02
USPC 384/428

(57) ABSTRACT

A connection structure for a shaft and a bearing includes a shaft and at least one bearing. The bearing has a shaft hole for the shaft to insert therein, a first face and a second face opposite to the first face. An outer circumference of the shaft is welded with a circumference of the shaft hole in adjacency to the first face of the bearing to form at least one first welding section connected between contact sections of the outer circumference of the shaft and the circumference of the shaft hole in adjacency to the first face. Via the first welding section, the shaft is integrally connected with the bearing. Therefore, the shaft and the bearing are more securely fixed with each other and the manufacturing cost is lowered.

### BACKGROUND OF THE INVENTION

1. Field of the Invention

The present invention relates generally to a connection structure for a shaft and a bearing, and more particularly to a connection structure for a shaft and a bearing, which can more securely connect the shaft with the bearing. Moreover, the connection structure is easy to process so that the manufacturing cost is lowered.

2. Description of the Related Art

Along with the rapid advance of electronic sciences and technologies, various electronic products have been popularly used in our daily life. For example, all kinds of electronic products are widely applied to domestic electrical appliances, computers, consumptive communication instruments and commercial communication apparatuses. These electronic apparatuses have complicated software and hardware with powerful functions. In general, the electronic apparatuses are inbuilt with numerous high-level and multiplex processing circuits or calculating chips. The temperature of these electronic components must keep below a certain value. Otherwise, the lifetime of the electronic components will be shortened due to overheating or even the electronic components will damage. In general, a cooling fan is the most often used active heat dissipation measure for an electronic product. The demand of various electronic products for high-efficiency cooling fan has become higher and higher. When the arrangement of the cooling fan reaches a design limit, the increase of rotational speed of the cooling fan is the only way to increase the total air volume.

The shaft and bearing of the fan are very important components that will affect the operation of the motor. In the case that the connection strength between the shaft and the bearing is weak, the lifetime of the fan will be shortened or even the bearing will damage and the shaft will break off. Under such circumstance, the fan will lose its function.

Conventionally, the shaft of the fan is connected with the bearing in two ways. The first way is to connect the shaft with the bearing by means of press fit. That is, the bearing is directly placed into a bearing cup of a base seat. Then the shaft is inserted into the shaft hole of the bearing and fixed with the bearing by means of press fit. There is a problem existing in such press fit manner, that is, both the shaft and the bearing are subject to wear and rusting. As a result, a gap will be formed between the shaft and the bearing. This will lead to loosening of the shaft and damage of the bearing or even malfunction of the fan. Moreover, with respect to a small-size fan, the structural strength of the bearing is so weak that the shaft can be hardly fixed with the bearing by means of press fit.

The second way is to connect the shaft with the bearing by means of an adhesive dispenser. To speak more specifically, the bearing is directly placed into a bearing cup of a base seat. Then the shaft is inserted into the shaft hole of the bearing. Then an adhesive dispenser is used to dispense adhesive between the shaft and the bearing so as to adhere the shaft to the bearing. There is a shortcoming existing in such connection manner. That is, the connection strength between the shaft and the bearing is too weak. In operation, the shaft will generate heat to cause rise of temperature. In the case that the temperature is higher than the melting point of the adhesive, the adhesive will melt to cause loosening of the shaft and damage of the bearing or even malfunction of the fan. Also, when dispensing the adhesive between the shaft and the bearing, it is hard to control the amount of the adhesive. In the case that too much adhesive is dispensed, the adhesive will spill to affect the operation of the bearing and deteriorate the heat dissipation effect of the fan.

According to the above, the conventional cooling fan has the following shortcomings:
1. The connection strength between the shaft and the bearing is weak so that the shaft cannot be securely fixed in the bearing. As a result, the lifetime of the fan is shortened.
2. The air volume is reduced.
3. With respect to a small-size fan, the structural strength of the bearing is so weak that the shaft can be hardly fixed with the bearing by means of press fit.

### SUMMARY OF THE INVENTION

It is therefore a primary object of the present invention to provide a connection structure for a shaft and a bearing, which can more securely connect the shaft with the bearing.

It is a further object of the present invention to provide the above connection structure for the shaft and the bearing, which is easy to process so that the manufacturing cost is lowered and the working time is shortened.

It is still a further object of the present invention to provide the above connection structure for the shaft and the bearing, which can prolong the lifetime of the fan.

To achieve the above and other objects, the connection structure for a shaft and a bearing of the present invention includes a shaft and at least one bearing. The shaft has a first end and a second end outward extending from the first end. The bearing has a shaft hole, a first face and a second face opposite to the first face. The shaft hole passes through a central section of the bearing for the shaft to insert therein. The bearing is positioned between the first and second ends. An outer circumference of the shaft is welded with a circumference of the shaft hole in adjacency to the first face of the bearing to form at least one first welding section connected between contact sections of the outer circumference of the shaft and the circumference of the shaft hole in adjacency to the first face. Via the first welding section, the shaft is integrally connected with the bearing. The shaft and the bearing are connected with each other by means of the first welding sections so that the shaft and the bearing are more securely fixed with each other. Moreover, it is convenient to connect the shaft with the bearing by means of welding so that the manufacturing cost is lowered.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a perspective exploded view of a first embodiment of the present invention;

FIG. 2A is a perspective assembled view of the first embodiment of the present invention;

FIG. 2B is an enlarged view of circled area 2B of FIG. 2A;

FIG. 3 is another perspective assembled view of the first embodiment of the present invention;

FIG. 4 is a perspective view of the fan impeller of the first embodiment of the present invention;

FIG. 5A is a perspective assembled view of a second embodiment of the present invention;

FIG. 5B is an enlarged view of circled area 5B of FIG. 5A; and

FIG. 6 is another perspective assembled view of the second embodiment of the present invention.

### DETAILED DESCRIPTION OF THE PREFERRED EMBODIMENTS

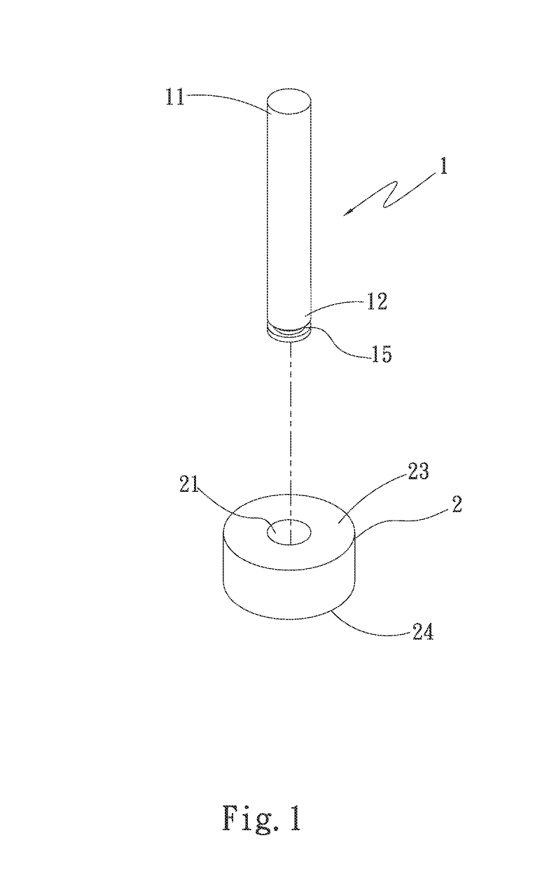

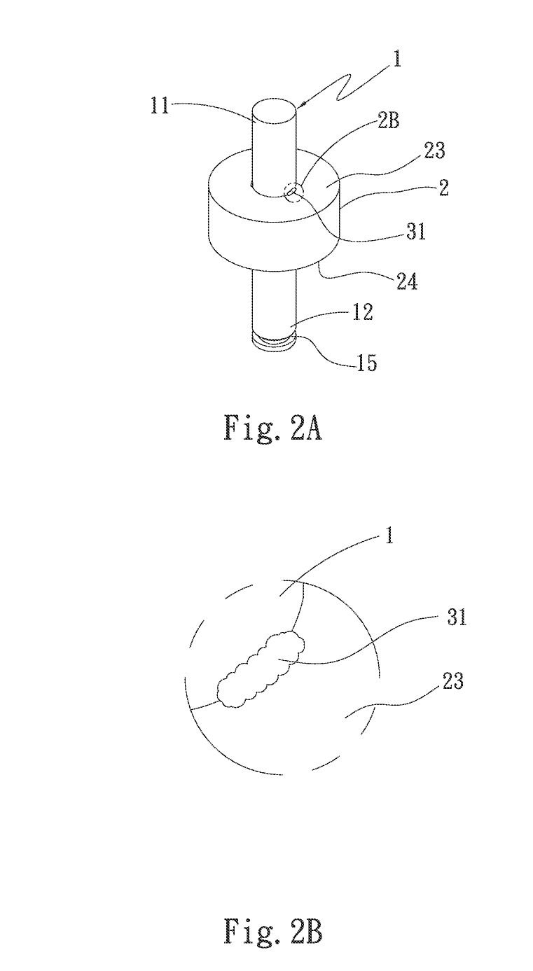

Please refer to FIGS. 1 and 2A as well as FIG. 4. FIG. 1 is a perspective exploded view of a first embodiment of the present invention. FIG. 2A is a perspective assembled view of the first embodiment of the present invention. FIG. 4 is a perspective view of the fan impeller of the first embodiment of the present invention. According to the first embodiment, the connection structure of the present invention is applied to a fan (not shown). The connection structure includes a shaft 1 and a bearing 2. The shaft 1 has a first end 11, a second end 12 outward extending from the first end 11 and an annular groove 15. In practice, the first end 11 is inserted in and fixed with a hub 40 of the fan. Multiple blades 41 are formed on an outer circumference of the hub 40 (as shown in FIG. 4).

In practice, the second end 12 is rotatably disposed in a bearing cup (not shown) of the fan. The annular groove 15 is formed at the second end 12 on an outer circumference of the shaft 1. A ring body such as a C-ring (not shown) is fixedly latched in the annular groove 15. In this embodiment, the bearing 2 is, but not limited to, a ball bearing for illustration purposes only. In practice, the bearing 2 can be alternatively an oil-retaining bearing or any other bearing. The number of the bearing 2 is adjustable according to the design requirement of the fan. For example, the shaft 1 can be fitted in two or more bearings.

The bearing 2 has a shaft hole 21, a first face 23 and a second face 24 opposite to the first face 23. The shaft hole 21 passes through the bearing 2 for the shaft 1 to insert therein. The bearing 2 is positioned between the first and second ends 11, 12. The annular groove 15 is positioned between the second face 24 of the bearing 2 and the second end 12 of the shaft 1. An outer circumference of the shaft 1 is welded with a circumference of the shaft hole 21 in adjacency to the first face 23 of the bearing 2 by means of laser processing (such as laser welding) to form at least one first welding section 31 connected between the contact sections of the outer circumference of the shaft 1 and the circumference of the shaft hole 21 in adjacency to the first face 23. Via the first welding section 31, the shaft 1 is integrally connected with the bearing 2 by means of laser welding to effectively enhance the structural strength and connection strength between the shaft 1 and the bearing 2. Accordingly, the shaft 1 and the bearing 2 are more securely fixed with each other to prolong the lifetime of the fan. Moreover, the air volume of the fan is effectively increased. Also, it is convenient to connect the shaft 1 with the bearing 2 by means of laser welding. The laser processing can be single-point or multipoint laser beam.

Please further refer to FIGS. 1, 2A and 2B. In this embodiment, the first welding section 31 is connected between the outer circumference of the shaft 1 and the circumference of the shaft hole 21 in adjacency to the first face 23 in, but not limited to, two aspects. In practice, the contact sections of the shaft 1 and the bearing 2 can be connected by means of laser welding in any other suitable manners. The two aspects are as follows:

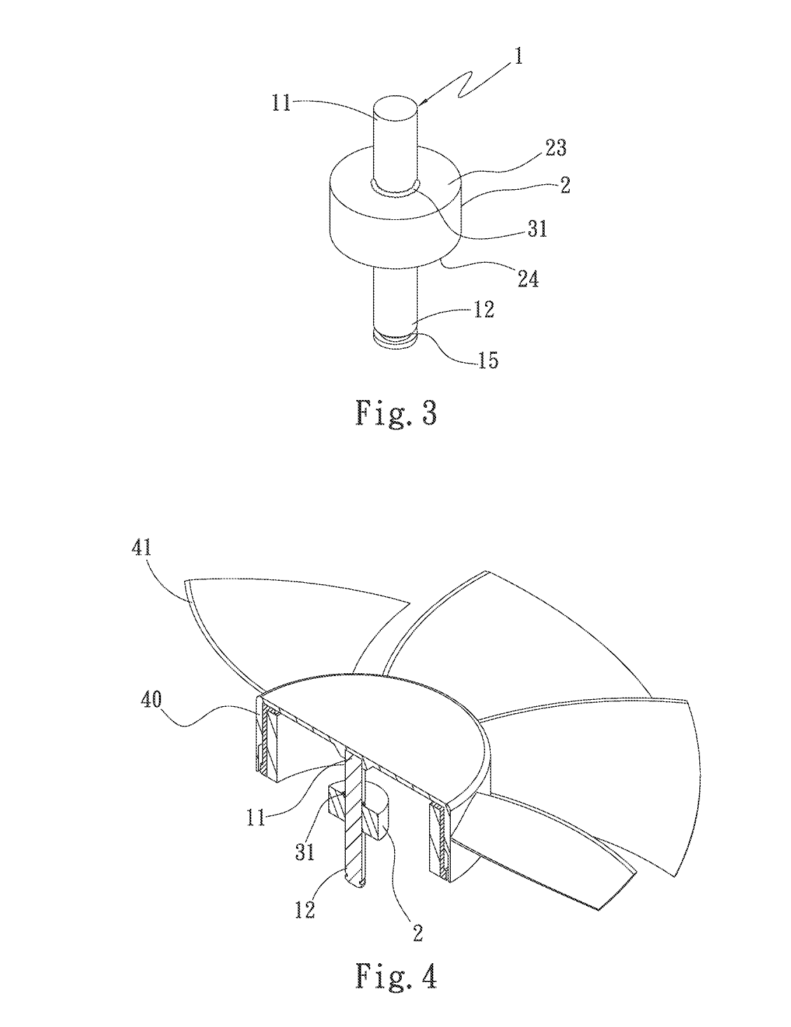

First aspect: Please refer to FIGS. 1 and 3. Multiple first welding sections 31 are formed between the contact sections of the outer circumference of the shaft 1 and the circumference of the shaft hole 21 in adjacency to the first face 23. The first welding sections 31 are annularly arranged along the outer circumference of the shaft 1 in adjacency to the first face 23.

Second aspect: Please refer to FIGS. 2A and 2B as well as FIG. 1. Multiple first welding sections 31 are formed between the contact sections of the outer circumference of the shaft 1 and the circumference of the shaft hole 21 in adjacency to the first face 23. The first welding sections 31 are symmetrically arranged (or asymmetrically arranged).

According to the above arrangement, the outer circumference of the shaft 1 is integrally welded with the circumference of the shaft hole 21 in adjacency to the first face 23 to form multiple first welding sections 31 between the contact sections of the outer circumference of the shaft 1 and the circumference of the shaft hole 21 in adjacency to the first face 23. Therefore, the shaft 1 and the bearing 2 are more securely fixed with each other to prolong the lifetime of the fan. Moreover, the air volume of the fan is effectively increased. Also, it is convenient to connect the shaft 1 with the bearing 2 by means of laser welding so that the manufacturing cost is lowered and the working time is shortened.

Furthermore, connection structure of the present invention is applicable to both large-size fan and small-size fan. Therefore, the problem that the structural strength of the shaft or the bearing of the small-size fan is so weak that the shaft can be hardly fixed with the bearing can be solved. Also, the problem of weak connection strength between the shaft and the bearing is overcome.

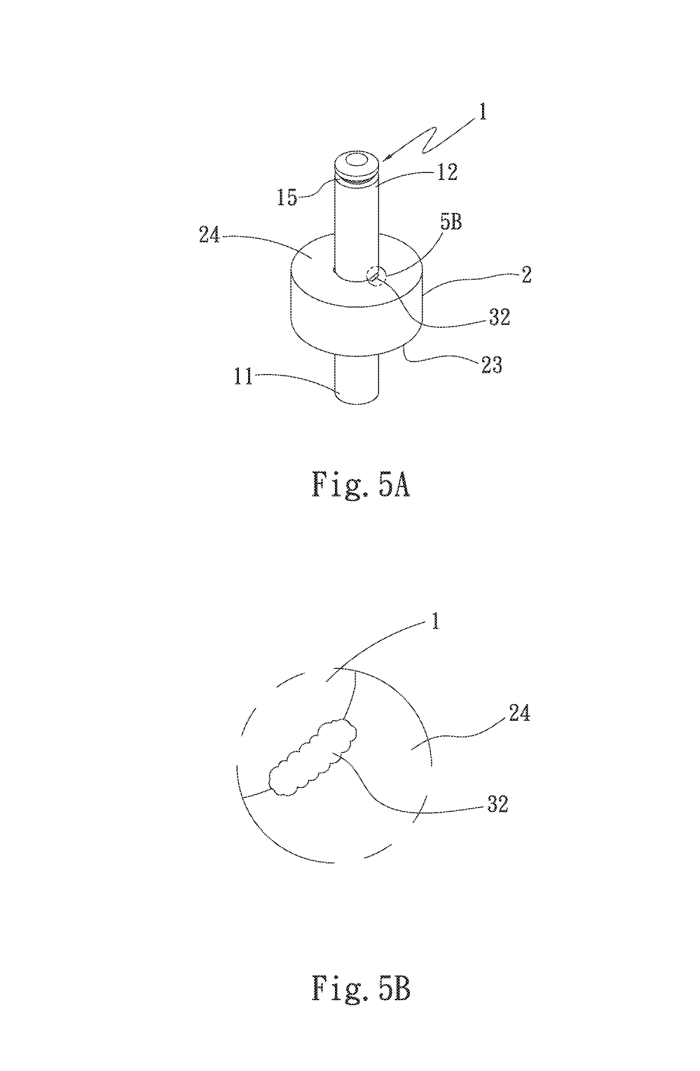

Please now refer to FIGS. 5A and 5B as well as FIG. 3. FIG. 5A is a perspective assembled view of a second embodiment of the present invention. FIG. 5B is an enlarged view of circled area 5B of FIG. 5A. The second embodiment is substantially identical to the first embodiment in structure, connection relationship and effect and thus will not be repeatedly described. The second embodiment is different from the first embodiment in that an outer circumference of the shaft 1 is welded with a circumference of the shaft hole 21 in adjacency to the second face 24 of the bearing 2 by means of laser processing (such as laser welding) to form at least one second welding section 32 connected between the contact sections of the outer circumference of the shaft 1 and the circumference of the shaft hole 21 in adjacency to the second face 24. Via the first and second welding sections 31, 32, the shaft 1 is integrally connected with the bearing 2 by means of laser welding to effectively enhance the structural strength and connection strength between the shaft 1 and the bearing 2. Accordingly, the shaft 1 and the bearing 2 are more securely fixed with each other. Moreover, the air volume of the fan is effectively increased. Also, it is convenient to connect the shaft 1 with the bearing 2 by means of laser welding. The laser processing can be single-point or multipoint laser beam.

In this embodiment, similar to the first welding section 31 of the first embodiment, the second welding section 32 is connected between the outer circumference of the shaft 1 and the circumference of the shaft hole 21 in adjacency to the second face 24 in, but not limited to, two aspects. The two aspects are as follows:

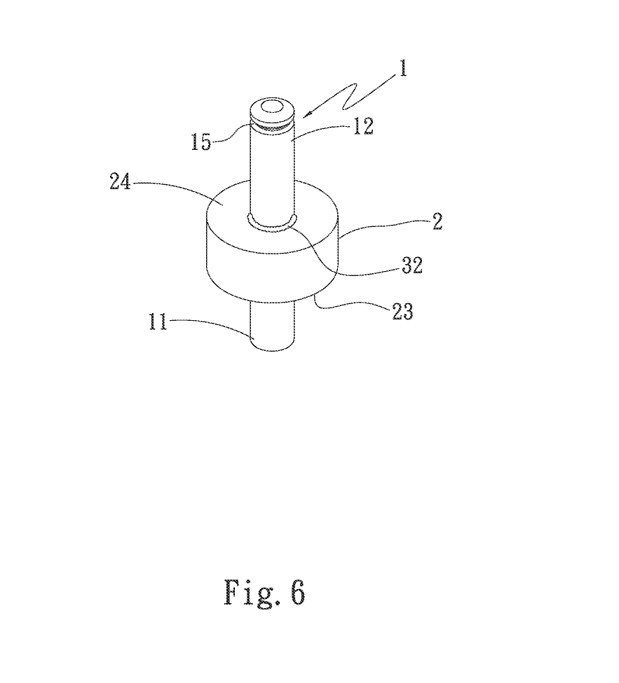

First aspect: Please refer to FIG. 6 as well as FIG. 1. Multiple second welding sections 32 are formed between the contact sections of the outer circumference of the shaft 1 and the circumference of the shaft hole 21 in adjacency to the second face 24. The second welding sections 32 are annularly arranged along the outer circumference of the shaft 1 in adjacency to the second face 24.

Second aspect: Please refer to FIGS. 5A and 5B as well as FIG. 1. Multiple second welding sections 32 are formed between the contact sections of the outer circumference of the shaft 1 and the circumference of the shaft hole 21 in adjacency to the second face 24. The second welding sections 32 are symmetrically arranged (or asymmetrically arranged).

In practice, the first and second aspects of the first and second welding sections 31, 32 can be cooperatively employed according to the requirements for appearance, structural strength, connection force and stability of the bearing 2. For example, the first aspect of the first welding sections 31 (as shown in FIG. 3) can be employed along with the first aspect of the second welding sections 32 (as shown in FIG. 6). Alternatively, the first aspect of the first welding sections 31 (as shown in FIG. 3) can be employed along with the second aspect of the second welding sections 32 (as shown in FIG. 5A). Still alternatively, the second aspect of the first welding sections 31 (as shown in FIG. 2A) can be employed along with the first aspect of the second welding sections 32 (as shown in FIG. 6). Still alternatively, the second aspect of the first welding sections 31 (as shown in FIG. 2A) can be employed along with the second aspect of the second welding sections 32 (as shown in FIG. 5A).

According to the above arrangement, the outer circumference of the shaft 1 is integrally welded with the circumferences of the shaft hole 21 in adjacency to the first and second faces 23, 24 to form multiple first and second welding sections 31, 32 between the contact sections of the outer circumference of the shaft 1 and the circumferences of the shaft hole 21 in adjacency to the first and second faces 23, 24. Therefore, the shaft 1 and the bearing 2 are more securely fixed with each other. Moreover, the air volume of the fan is effectively increased. Also, it is convenient to connect the shaft 1 with the bearing 2 by means of laser welding so that the manufacturing cost is lowered and the working time is shortened.

In conclusion, in comparison with the conventional connection structure, the present invention has the following advantages:
1. The structural strength and connection strength between the shaft and the bearing are enhanced so that the shaft can be more securely fixed in the bearing.
2. The lifetime of the fan is prolonged and the air volume of the fan is increased.
3. It is convenient to connect the shaft with the bearing by means of laser welding so that the manufacturing cost is lowered and the working time is shortened.

The present invention has been described with the above embodiments thereof and it is understood that many changes and modifications in the above embodiments can be carried out without departing from the scope and the spirit of the invention that is intended to be limited only by the appended claims.

What is claimed is:

1. A connection structure for a shaft and a bearing, comprising:
a shaft having a first end and a second end outward extending from the first end; and
at least one bearing having a shaft hole, a first face and a second face opposite to the first face, the shaft hole passing through a central section of the bearing for the shaft to insert therein, the bearing being positioned between the first and second ends, an outer circumference of the shaft being welded with a circumference of the shaft hole in adjacency to the first face of the bearing to form at least one first welding section connected between contact sections of the outer circumference of the shaft and the circumference of the shaft hole in adjacency to the first face, via the first welding section, the shaft being integrally connected with the bearing.

2. The connection structure for the shaft and the bearing as claimed in claim 1, wherein the outer circumference of the shaft is welded with the circumference of the shaft hole in adjacency to the first face by means of laser welding to form the first welding section, the first welding section being annularly arranged along the outer circumference of the shaft in adjacency to the first face.

3. The connection structure for the shaft and the bearing as claimed in claim 2, wherein the outer circumference of the shaft is welded with a circumference of the shaft hole in adjacency to the second face of the bearing by means of laser welding to form at least one second welding section connected between contact sections of the outer circumference of the shaft and the circumference of the shaft hole in adjacency to the second face, the second welding section being annularly arranged along the outer circumference of the shaft in adjacency to the second face.

4. The connection structure for the shaft and the bearing as claimed in claim 1, wherein the outer circumference of the shaft is welded with the circumference of the shaft hole in adjacency to the first face by means of laser welding to form the first welding section, the first welding section being symmetrically arranged or asymmetrically arranged.

5. The connection structure for the shaft and the bearing as claimed in claim 4, wherein the outer circumference of the shaft is welded with a circumference of the shaft hole in adjacency to the second face of the bearing by means of laser welding to form at least one second welding section connected between contact sections of the outer circumference of the shaft and the circumference of the shaft hole in adjacency to the second face, the second welding section being symmetrically arranged or asymmetrically arranged.

6. The connection structure for the shaft and the bearing as claimed in claim 3, wherein the shaft further has an annular groove formed at the second end on an outer circumference of the shaft, the annular groove being positioned between the bearing the second end.

7. The connection structure for the shaft and the bearing as claimed in claim 5, wherein the shaft further has an annular groove formed at the second end on an outer circumference of the shaft, the annular groove being positioned between the bearing the second end.
